(19) United States
(12) Patent Application Publication
(10) Pub. No.: US 2024/0009684 A1
(43) Pub. Date: Jan. 11, 2024

(54) RETAINING RING FOR A CENTRIFUGE

(71) Applicant: THERMO ELECTRON SAS, VILLEBON-SUR-YVETTE (FR)

(72) Inventor: Benoit Jean LIMON, VILLEBON-SUR-YVETTE (FR)

(21) Appl. No.: 18/218,892

(22) Filed: Jul. 6, 2023

(30) Foreign Application Priority Data
Jul. 8, 2022 (EP) EP22315139.0

(51) Int. Cl. B04B 7/02; B04B 7/08

(52) U.S. Cl. CPC B04B 7/02; B04B 7/08

(57) ABSTRACT

A retaining ring arrangement for a centrifuge rotor of a centrifuge, comprising a base, having a planar portion with an aperture centrally therethrough, the base further having a perimeter wall extending upwardly from the planar portion to define a cavity bounded by the planar portion and the perimeter wall. The retaining ring arrangement further comprises a lid, being a further planar portion with an aperture centrally therethrough, configured to be placed on the perimeter wall of the base and opposite the planar portion of the base so that a central axis through the aperture through the planar portion of the base aligns to a central axis through the aperture through the planar portion of the lid. The retaining ring arrangement also comprises a lid-locking mechanism at the lid and at the base, so that when the lid-locking mechanism is closed it connects the base and the lid.

### CROSS-REFERENCE TO RELATED APPLICATION

This application claims priority to foreign European patent application No. EP22315139.0, filed on Jul. 8, 2022, the disclosure of which is incorporated by reference in its entirety.

### FIELD OF THE INVENTION

The invention relates to a retaining ring arrangement and a centrifuge comprising it, for instance a laboratory centrifuge. Further disclosed is a tubing assembly for connection to a plurality of sample containers and for use with the retaining ring arrangement. The retaining ring arrangement securely holds sections of a hose of the tubing assembly in the centrifuge, and encloses a volume into which portions of the tubing assembly can be contained during use.

### BACKGROUND

A centrifuge is a commonly used item of laboratory equipment. A centrifuge makes use of centrifugal force in order to separate components of a sample, wherein the sample is rotated at high speed around a rotation axis in order to generate said centrifugal force. Types of sample that may be processed in this way include mixtures of biological or microbiological samples. The samples typically comprise a component to be investigated suspended in a liquid.

In order to introduce a sample into the centrifuge, the sample is contained within a sample container. Different types of sample container may be used, which can be received into sample receptacles arranged around the rotation axis (normally at a centrifuge rotor). Known types of sample container include plastic bottles (single use or reusable, in some cases including a tube through a lid for filling with sample) or single-use film bags. The sample container should typically be sterile before filling with a sample to be centrifuged, and the process for filing reusable sample containers with sample becomes more complex and slow as a result.

The use of single use film bags as containers for a sample can greatly simplify the transfer and centrifugation of a sample under sterile conditions. Different types of single-use film sample bags are described in International Patent Publication No. WO/2019/166998, which is herein incorporated by reference. Accordingly to International Patent Publication No. WO/2019/166998 a supply hose branches in a cascading manner, so that each branch splits until a sub-branch connects to one of a plurality of single-use film bags. This set of interconnecting hoses can be considered a tubing assembly. The tubing assembly allows all the single-use film bags to be filled simultaneously by connection of the supply hose to a sample reservoir. Each film sample bag can then be closed by using a closure device to block the branch serving each given film bag. Each film bag can then be separated from the main portion of the tubing assembly for placing in the centrifuge. Such a system reduces the time for filling the sample containers and makes it easier to maintain sterile conditions for filling.

The sample film bags and system described in International Patent Publication No. WO/2019/166998 work well to facilitate a single stage of centrifugation. However, it is often required to perform various stages of centrifugation, with different solvents or suspensions being added to each sample container between sessions of centrifugation. In the system described in International Patent Publication No. WO/2019/166998, after a first session of centrifugation, the sample bags can be removed from the centrifuge and each individually attached to the same (or a new) branched supply line to add a further substance before further processing. However, detaching and reattaching sample bags to a supply line is time consuming, and labour intensive.

The situation can be improved by providing a system in which the supply line is not removed, but instead retained as attached to the individual sample bags during centrifugation. Nevertheless, this poses a problem when loading the sample bags into a centrifuge, as during the rotational motion the supply line can cause damage (both to the centrifuge and the sample bags) or become detached if it is left free to rotate. US Patent Publication No. US 2021/016296 (incorporated herein by reference) looks to address this problem. This document describes a retaining ring and centrifuge rotor. The retaining ring of US Patent Publication No. US 2021/016296 comprises a central base enclosing a circular base body and tines extending out from the base body and extending away from the top of the rotor body upwardly. The retaining ring is arranged on top of the rotor body so that the rotation axis passes through the central opening. Hoses connected to the individual sample bags can be wedged between tines of the retaining ring and the hub of the centrifuge rotor, in order to prevent the hoses from moving around during centrifugation. A lid, comprising a circular base body and tines extending therefrom, can also be applied. The lid can be arranged on the base body, so that the tines interleave. This acts further to hold the hose between the tines of a base portion and the centrifuge rotor.

Although this retention of the supply line of a tubing assembly can allow easier processing of samples, the set-up of the centrifuge using a retaining ring according to US Patent Publication No. US 2021/016296 can be awkward and time consuming. Therefore, an improved system is desired.

### SUMMARY OF THE INVENTION

This disclosure describes a retaining ring arrangement (or crown) for use on a centrifuge rotor of a centrifuge. The retaining ring may be placed on the uppermost portion of the centrifuge rotor when in use in a centrifuge. In particular, the retaining ring arrangement comprises a base being a rotationally symmetric cup portion (such as an annular portion, with side walls at the outer perimeter) and a lid, for enclosure of a volume within the cup portion. The base and the lid each have a central opening or hole therethrough, and can be connected together using a lid-locking mechanism. One or more notches or cut-outs are provided at the side walls of the cup portion.

In use, the retaining ring arrangement can be placed on the centrifuge rotor so that a central rotation axis around which the centrifuge rotor rotates aligns with a central axis of the opening or hole in the base and/or lid of the retaining ring arrangement. In particular, a hub portion of the centrifuge rotor arranged around a rotor shaft of the centrifuge can be passed at least partially through the central opening in the lid and base of the retaining ring arrangement. A tube or hose assembly can be arranged in conjunction with the retaining ring arrangement so that a feed hose, connecting a main hose to a sample container held in a receptacle of the centrifuge rotor, passes though each notch in the side walls of the cup portion. The main hose can then be enclosed within the volume contained between the cup portion and the lid of the retaining ring arrangement when the centrifuge is in use (for instance by coiling the main hose around the hub portion of the centrifuge rotor inside the cup portion and then connecting the lid and cup portion using the lid-locking mechanism).

Provision of a volume enclosed between the lid and the base of the retaining ring arrangement allows the main hose of a tubing assembly used within the centrifuge to be entirely contained. By containing the hose, the likelihood of damage to the centrifuge or the sample as a result of the rotation of the centrifuge is reduced. As a whole, the described retaining ring arrangement facilitates more straightforward and accurate set-up of a samples in a centrifuge (where samples are held in sample containers connected by a tubing assembly). Consequently, the user saves time, and the possibility of damage as a result of incorrect set-up is minimised.

Fins may further be applied to the base of the retaining ring arrangement, to facilitate secure fitting of the retaining ring arrangement on the hub of the centrifuge rotor. In particular, when fins are arranged protruding from the bottom surface of the retaining ring arrangement, configured so as to allow them to be inserted between radially extending arms of the centrifuge rotor, then the retaining ring arrangement is necessarily aligned on the centrifuge rotor. Moreover, any rotational motion relative to the centrifuge rotor when the centrifuge is in use can be prevented.

This disclosure further describes a tubing assembly, for use with the discussed retaining ring arrangement. The tubing assembly comprises a main line, and a plurality of feed lines connected directly to the main line in sequence. Each feed line joins the main line to a sample container, such as a film sample bag. The spacing between the connection of a pair of adjacent feed lines to the main line can be approximately equal to the length of the arc between the centre of two notches in the side walls of the base of a given retaining ring arrangement, as described above, with which the tubing assembly is to be used. Here ‘approximately’ means within ±10%, or more preferably within ±5%.

The tubing assembly provides all the advantages of a prior art tubing assembly, such as easier and quicker filling of a sample in sample containers, especially under sterile conditions. However, the tubing assembly has particular advantages if used in conjunction with the described retaining ring arrangement. In particular, the spacing of the connections of the feed hoses to the main hose can be made to better fit within the volume enclosed inside the retaining ring arrangement, which reduces complexity of the set-up of samples in the centrifuge for a user.

In a first aspect there is a retaining ring arrangement for a centrifuge rotor of a centrifuge, comprising:
a base, having a planar portion with an aperture centrally therethrough, the base further having a perimeter wall extending upwardly from the planar portion to define a cavity bounded by the planar portion and the perimeter wall; and
a lid, being a further planar portion with an aperture centrally therethrough, configured to be placed on the perimeter wall of the base and opposite the planar portion of the base so that a central axis through the aperture through the planar portion of the base aligns to a central axis through the aperture through the planar portion of the lid;
a lid-locking mechanism at the lid and at the base, so that when the lid-locking mechanism is closed it connects the base and the lid;
wherein when the base and the lid are connected the cavity is enclosed between the base and the lid to provide a volume for containing at least a portion of a hose of a tubing assembly used in the centrifuge.

The planar portion and perimeter wall of the base form a cup-like or bowl-like structure, and the lid is a cover or closure, to enclose the cavity defined in said cup-like or bowl-like structure. The lid may itself have perimeter walls and be cup-like or bowl-like (for instance, the perimeter walls of the lid being shallower in depth than the perimeter walls of the base). It will be understood that although the use of the terms ‘lid’ and ‘base’ imply a lower and upper portion, these relative positions should not be construed as limiting to how the retaining ring arrangement could be used on the centrifuge rotor (and so, for instance, the shallower or planar lid could be arranged on hub of the centrifuge rotor, with the cup-like base placed on top). The perimeter wall extending upwardly is intended to be construed relative to the planar portion, and so to mean that that the perimeter wall extends approximately perpendicularly from the planar portion so as to provide side walls to a cavity bounded by the perimeter walls and the planar portion. Upwardly should not be construed as limiting to the direction of use of the base and lid portion relative to the centrifuge rotor.

The planar portions of the lid and the base will be rotationally symmetric around the central axis through the aperture in the lid and base respectively. In some examples, the planar portions may be circular (and so, taken together with the central opening, have an annular or ring-shape), or the planar portions could be pentagonal, hexagonal, octagonal or another polygonal shape. Where the planar portion is a polygonal shape, this may refer to a ‘true’ polygon, or one with smoothed corners. Moreover, some serration or crenellations may be arranged at the outermost perimeter edge of the planar portion of either or both of the base or lid, in order to provide better grip and handling (for instance, in opening and closing of the lid-locking mechanism, especially where this is a screw thread).

When the retaining ring arrangement is placed inside the centrifuge, a hub portion of the centrifuge rotor (arranged around the rotator shaft of the centrifuge) may extend at least partially through the central opening of the lid and the base. Consequently, the volume defined inside the retaining ring arrangement may be an approximately torus-shaped volume defined between the base and lid of the retaining ring and the hub of the centrifuge rotor. The volume provides a space in which a hose or tubing connected to sample containers in a centrifuge can be stowed or contained whilst the centrifuge is in use.

The perimeter wall will be understood to be a wall that defines the outer or side boundary of a cavity contained within the base. The perimeter wall may extend upwardly from the radially outermost edge of the planar portion of the base (and/or lid, if perimeter walls are provided at the lid). However, the perimeter wall may also extend upwardly from the planar portion of the base at a position inside the radially outmost edge (thereby forming a lip at the outermost edge). In any case, the perimeter wall and planar portion together provide the base which defines a cavity (giving a cup-like structure).

Preferably, the perimeter wall may extend perpendicularly from or orthogonal to the plane of the planar portion. However, the perimeter wall may extend upwardly at an angle between 70° and 110° with respect to the plane of the planar portion of the base. The angle may be chosen so as to best fit on the centrifuge rotor.

The base of the retaining ring arrangement may be formed as a single piece (wherein the planar portion and perimeter walls are a single entity). For instance, the base and the lid may be made of plastic, and could be manufactured using an injection moulding process.

The centrifuge rotor may be of any known type, including a swing-out rotor or a fixed-angle rotor. The centrifuge rotor may be of a type described in US Patent Publication No. US 2021/016296.

The perimeter wall may be configured having at least one notch for receiving a further portion of a hose of the tubing assembly therethrough. In other words, a feed hose of a tubing assembly can pass through an opening or cut-out in the upper edge of the perimeter wall of the base (and/or the perimeter wall of the lid, if the lid has a perimeter wall). Beneficially, this allows the main hose to be contained within the volume inside the retaining ring arrangement, whereas the feed hose can pass through the perimeter wall (whilst still connected to the main hose) to a sample container held in receptacles at the centrifuge rotor.

Each notch can extend the full height or part of the height of the perimeter wall. Ideally, the notch has a width greater than or equal to an outer diameter of a feed hose of the tubing assembly that is to be received therethrough. The notches could be slightly less (up to 5% less) wide than the outer diameter of a feed hose of the tubing assembly that is to be received therethrough, in order to pinch the tube and hold it in place. Any number of notches could be arranged in the perimeter wall, although ideally the number of notches corresponds to the number of sample receptacles in the centrifuge rotor (and so the number of feed hoses within the tubing assembly to be used in conjunction with the retaining ring arrangement). In one example, the perimeter wall may comprise six notches or may comprise eight notches (because, as will be understood by the skilled person, typically centrifuge rotors have six or eight sample receptacles).

The perimeter wall may comprise at least a first and a second wall portion, and a first notch of the at least one notch is configured as a gap between the first and the second wall portion. In other words, the notch is the full depth of the cavity contained in the base, such that the perimeter wall can be considered to be separated into a plurality of wall portions with a notch therebetween. For instance, the perimeter wall comprises six wall portions with six notches, each notch configured as a gap between pairs of adjacent wall portions, or the perimeter wall comprises eight wall portions with eight notches, each notch configured as a gap between pairs of adjacent wall portions. The number of wall portions and the number of notches may correspond to the number of sample receptacles in the centrifuge rotor.

The retaining ring arrangement may further comprise one or more fins extending downwardly from the planar portion of the base, the one or more fins extending in a direction opposite to the extension of the perimeter wall. In this case, ‘downwardly’ should be considered only as a relative term to the ‘upward’ extension of the perimeter wall. In other words, the fins may protrude perpendicularly from a ‘bottom’ surface of the planar portion of the base, so that the fins extend from the planar portion in an opposite direction to the perimeter wall. The one or more fins may be configured so that, when the retaining ring arrangement is placed on a central body of the centrifuge rotor, the fins are arranged to protrude between arms extending radially outward from the central body of the centrifuge rotor.

The lid-locking mechanism, when closed, may connect the perimeter wall of the base with the lid. The lid-locking mechanism may be a cooperating screw thread, such as a screw thread between the perimeter wall of the base and the lid, although any other type of lid-locking mechanism between the base and the lid could be used. For instance, an interference fit (push fit) connection or clips or clasps between the lid and the base could be used. Any lid-locking mechanism should securely hold the lid and base together to enclose a volume whilst the retaining ring arrangement is in use in a centrifuge.

The central aperture in the planar potion of the base and the central aperture in the planar potion of the lid may be configured to receive at least part of a central rotator hub of the centrifuge rotor therethrough. The central rotator hub is a central portion of the centrifuge rotor that can be mounted on the central rotation shaft (drive shaft) of the centrifuge. The central rotor hub will be arranged symmetrically around the axis of rotation of the rotor shaft of the centrifuge and, ideally, the retaining ring arrangement will also be configured to be rotationally symmetric around the axis of rotation of the rotor shaft. In other words, in use, the retaining ring arrangement may be arranged at the centrifuge rotor so that the central axis through the aperture through the planar portion of the base and the lid coincides with an axis of rotation of the centrifuge rotor.

In a second aspect there is a tubing assembly for connecting a plurality of sample containers for use in a centrifuge, comprising:
a main hose; and
a plurality of feed hoses, each feed hose at a first end being directly connected to the main hose;
wherein a different sample container of the plurality of sample containers is directly connected to a second end of each feed hose of the plurality of feed hoses, the second end being opposite to the first end.

The tubing assembly provides a convenient and quick method of filling the plurality of sample containers with a sample, and for adding further solvents or substances for further processing after a first period of centrifugation. The tubing assembly also assists with handling of the sample in a sterile manner. The tubing assembly can be kept connected to the sample containers during centrifugation when the tubing assembly is used in conjunction with the presently described retaining ring arrangement.

The tubing assembly, having the plurality of feed hoses each connected to a single sample container and branching directly from the main hose (rather than in a hierarchical staged manner, in which a first hose connected to the main line is split into multiple further branches before connection to the sample containers, as shown in prior art configurations), is particularly beneficial for use with the described retaining ring arrangement. In particular, the presently disclosed tubing assembly can be arranged so that a portion of the main hose is looped inside the volume of the retaining ring arrangement such that the feed lines each extend radially outwards from the loop. Each radially extending feed hose can pass through a notch in the perimeter wall of the retaining ring arrangement, in order to extend to the sample container to which it is connected.

The tubing assembly may further comprise the plurality of sample containers, and preferably the sample containers may be single-use sample bags. The sample containers may each be of a type selected from any one of: a bottle which can be closed with a cap, wherein the second end of at least one feed hose is guided through an opening in the cap; and a film bag in which the second end of at least one feed tube is sealed. The single-use sample bags may be film bags, which can be especially useful for maintaining a sterile environment for the sample during handling. Each centrifuge sample container may be connected to a different feed hose (so that there is a dedicated feed hose for each single use sample container), although other hoses or ports may be provided at one or more of the sample containers too. For instance, a draining port or tap may be provided at a sample container.

The main hose and feed hoses can each comprise a hose, line or tube, and so the tubing assembly is a set of interconnected hoses, lines or tubes. The main hose may comprise a manifold portion (being the section or length of the main hose at which the feed hoses are connected) and a supply line portion (being a section or length of the main hose for connecting the manifold portion of the main hose to a reservoir of sample, to allow filling of sample containers connected to the feed hose).

A first feed hose may be connected to the main hose and a second feed hose may be connected to the main hose adjacent the connection of the first feed hose, and a spacing along the main hose between the connection of the first hose and the second hose to the main hose may be substantially equal to a length of an arc between a centre of two rotationally adjacent notches in a retaining ring arrangement, as described above, with which the tubing assembly is to be used. Here, ‘substantially equal’ means within ±5%.

In a third aspect there is a centrifuge, comprising:
a centrifuge rotor; and
the retaining ring arrangement as described above;
wherein the retaining ring is arranged on the centrifuge rotor such that the central axis through the aperture through the planar portion of the base and the lid coincides with an axis of rotation of the centrifuge rotor. The retaining ring may be arranged on a top side of the centrifuge rotor facing away from an insertion side of the centrifuge rotor into the centrifuge.

The centrifuge rotor may comprise one or more sample receptacles each for receiving one of a plurality of sample containers; and
the centrifuge may further comprise:
   a tubing assembly, comprising a main hose and a plurality of feed hoses, each feed hose connected to a respective one of the plurality of sample containers;
wherein the tubing assembly is arranged in the centrifuge rotor so that each of the plurality of sample containers is arranged in a respective sample receptacle, and wherein at least a portion of the main hose of the tubing assembly is contained in the volume of the retaining ring arrangement.

The centrifuge rotor may be a swing-out rotor, the swing-out rotor comprising a central body and holding arms extending radially outward therefrom, at the outer ends of each one is one of the one or more sample receptacles. Alternatively, the centrifuge rotor may be a fixed-angle rotor, wherein the sample receptacles are formed as recesses in a rotor body of the fixed-angle rotor. The centrifuge rotor may be of the type described in US Patent Publication No. US 2021/016296.

Preferably, the tubing assembly used in the centrifuge may be the tubing assembly described above. In this case, a section of at least one of the plurality of feed hoses passes through at least one notch in the perimeter wall of the base of the retaining ring arrangement. When the centrifuge is used in combination with the described retaining ring arrangement and tubing assembly, the hoses of the tubing assembly can be compactly stowed in the retaining ring arrangement when the centrifuge is in use (i.e. when the centrifuge rotor is under rotation). This prevents damage to the centrifuge or to samples therein. Furthermore, the retaining ring arrangement makes alignment of the hoses of the tubing assembly and arrangement of samples in sample containers when setting-up the centrifuge more straightforward and less vulnerable to user error.

### BRIEF DESCRIPTION OF THE DRAWINGS

The disclosure may be put into practice in a number of ways and preferred embodiments will now be described by way of example only and with reference to the accompanying drawings, in which:

FIG. 1 shows a schematic diagram of a conventional centrifuge;

FIG. 2 shows a centrifuge rotor known in the state of the art;

FIG. 3 shows a plan view of a retaining ring arrangement. FIG. 3(a) shows the lid of the retaining ring arrangement, and FIG. 3(b) shows the base of the retaining ring arrangement;

FIG. 4 shows a perspective view of the retaining ring arrangement of FIG. 3. FIG. 4(a) shows a perspective view of the lid of the retaining ring arrangement separated from the base, FIG. 4(b) shows a perspective view of the base of the retaining ring arrangement separated from the lid, FIG. 4(c) shows a perspective view of the lid and the base of the retaining ring arrangement with a connected lid and base, FIG. 4(d) shows a schematic representation of the configuration of a tubing assembly in the base of the retaining ring arrangement when in use within a centrifuge;

FIG. 5 shows images of a retaining ring arrangement having six notches in the perimeter wall. FIG. 5(a) shows a plan view of the upper surface of the lid (left hand side) and the base (right hand side) and FIG. 5(b) shows a plan view of the bottom surface of the lid (left hand side) and the base (right hand side);

FIG. 6 shows images a retaining ring arrangement having eight notches. FIG. 5(a) shows a plan view of the upper surface of the lid (left hand side) and the base (right hand side) and FIG. 5(b) shows a plan view of the bottom surface of the lid (left hand side) and the base (right hand side);

FIG. 7 shows a schematic diagram of a tubing assembly for connecting a plurality of sample containers for use in a centrifuge;

FIG. 8 shows a partially exploded view of a centrifuge rotor, retaining ring arrangement and lid; and

FIG. 9 shows images of the retaining ring arrangement in use within a centrifuge and arranged on a centrifuge rotor. FIGS. 9(a), 9(b) and 9(c) are a sequence of images showing steps for set-up of the retaining ring arrangement in the centrifuge.

In the drawings, like parts are denoted by like reference numerals. The drawings are not to scale.

### DETAILED DESCRIPTION

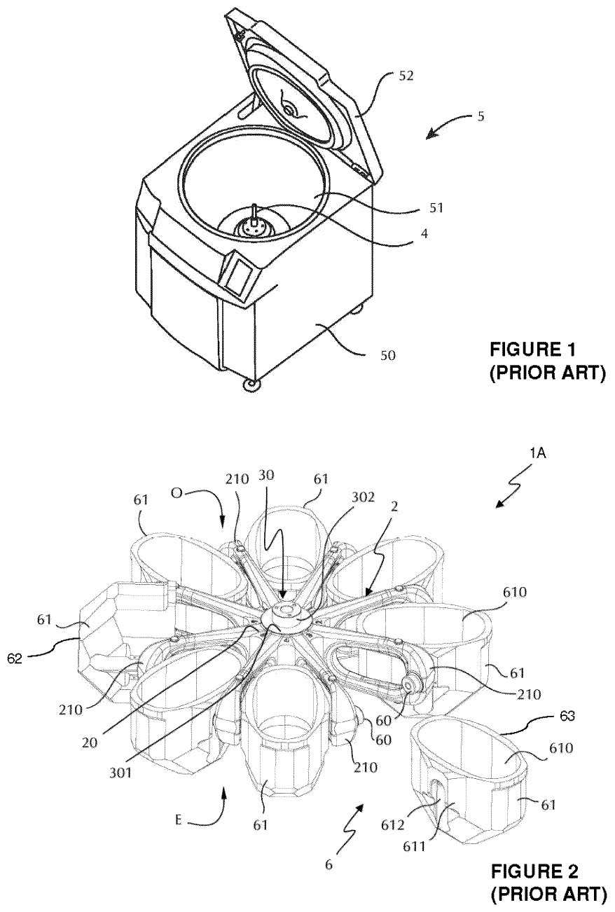

FIG. 1 shows the basic structure of a centrifuge as described in US Patent Publication No. US 2021/016296, which is preferably a laboratory centrifuge. The present invention, as described below, can be used in conjunction with such a centrifuge. In the specific example of FIG. 1, the centrifuge is a stand-alone unit which, due to its size, is suitable for centrifuging large sample containers. Nevertheless, the present invention could also be used in conjunction with other types of centrifuges such as table centrifuges.

The centrifuge 5 of FIG. 1 has, inside its housing 50, a cavity 51 which is a rotor chamber for receiving a centrifuge rotor. The centrifuge rotor is placed onto a drive head 4 protruding into the rotor chamber and connected to it in a rotationally fixed manner. The drive head 4 is set in rotation via a drive shaft coupled to a motor (not shown in FIG. 1). As a result of the rotation of the drive head 4, the centrifuge rotor and the sample containers accommodated therein rotate, as a result of which the samples contained in the sample containers are separated into their constituent parts according to their density, as a consequence of the generated centrifugal force. The rotor chamber 51 can be closed with a cover or lid 52, especially whilst in use.

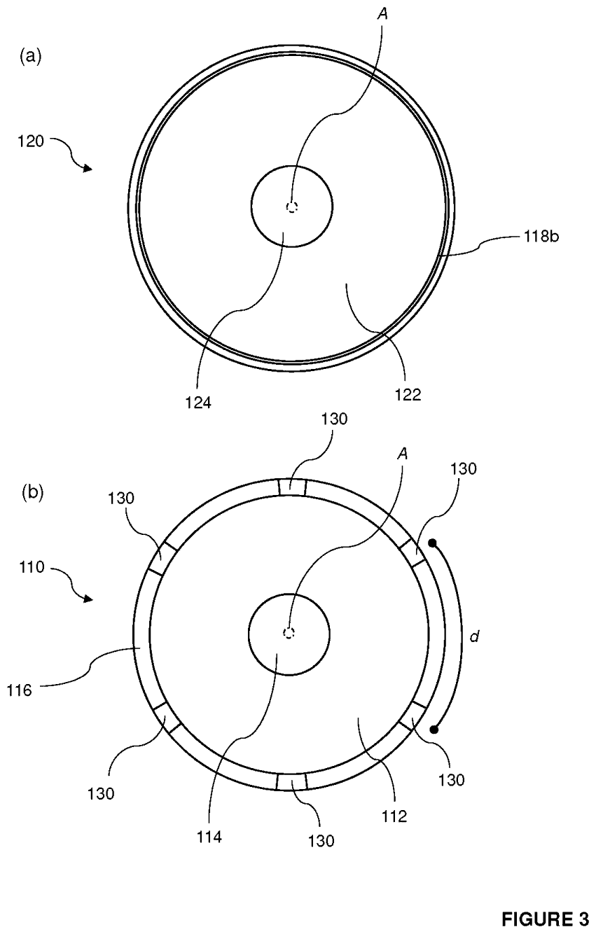

A conventional centrifuge rotor 1A is described with reference to FIG. 2. The present invention can be used in conjunction with such a centrifuge rotor 1A. The example of FIG. 2 is a swing-out centrifuge rotor, however any type of centrifuge rotors known from the prior art could be used, including either a swing-out rotor or a fixed-angle rotor. The term “swing-out rotor” designates centrifuge rotors in which the sample containers are pivotably mounted on holders on the rotor body and swing outward under the action of the centrifugal force during operation of the centrifuge. Usually, the sample containers are not mounted directly on the rotor body, but pivotably mounted centrifuge beakers are provided into which the sample containers are placed. An adapter can also be present between the centrifuge beaker and the sample container. In contrast, the term “fixed-angle rotor” denotes centrifuge rotors in which the sample containers do not pivot out during centrifugation, but are arranged at a constant angle with respect to the axis of rotation. For this purpose, the centrifuge rotor usually has correspondingly aligned recesses in the rotor body. The sample containers are either placed directly into the recesses or into adapters which are arranged in the recess.

The swing-out centrifuge rotor 1A of FIG. 2 has a rotor body 2 with a central body 20. In the example shown, eight holding arms 2 extend radially outward from the central body 20. Holders 60 in the form of holding pins extend from the outer ends 210 of the holding arms 2 on both sides. Centrifuge beakers 61 can be mounted on the holders so as to be pivotable about a pivot axis passing through the longitudinal axis of opposing holders 60. For this purpose, the centrifuge beakers 61 have projections 611 on opposite outer sides, each of said projections defining a receiving cavity 612 for a holder FIG. 2 shows a total of eight centrifuge beakers 61, seven of which are already attached to the holders 60. The centrifuge beaker 61, 62, which is arranged on the far left in the picture, is shown to illustrate the pivoting process in the pivoted-out state which occurs only during centrifugation. The six further attached centrifuge beakers are shown at rest, hanging downward in the direction of gravity. The eighth centrifuge beaker 61, 63, shown at the bottom right in the picture, has not yet been attached to the centrifuge rotor.

The holders 60 and centrifuge beakers 61 together form sample receptacles for the swing-out centrifuge rotor. Sample containers to be centrifuged can be placed in a cavity 610 defined in the centrifuge beakers 61 hanging on the holders 60. If necessary, an adapter (not shown here) can be arranged beforehand in the cavity 610 of the respective centrifuge beaker 61. Such adapters are used in a manner known per se to stabilize and protect the sample container in the centrifuge beaker. In the example shown, the interior cavity 610 of the centrifuge beaker 61 has an oval cross section. Correspondingly, the centrifuge beakers 61 are suitable for holding sample containers with an oval shape, but are designed here, in particular, for holding film bags. Nonetheless, various other sample container shapes are possible, with use of corresponding shapes for the interior cavity 610 of the centrifuge beakers 61.

Before a centrifugation process is performed, the centrifuge rotor 1A (such as that shown in FIG. 2) is first placed in the rotor chamber 51 of a centrifuge 5 (such as that shown in FIG. 1), and coupled to the drive head 4. The side of the centrifuge rotor 1A from which the drive head 4 is inserted into the centrifuge rotor is referred to below as the insertion side E. The side of the rotor body 2 opposite the insertion side E is referred to below as the top side O. In the example shown, a hub 30 at an opening of the central body 20 and essentially shaped as a sleeve, serves to receive the drive head 4 of the centrifuge 5. The hub 30 protrudes above the top side O of the rotor body 2. An annular disk shaped surface 301 laterally surrounds the hub 30.

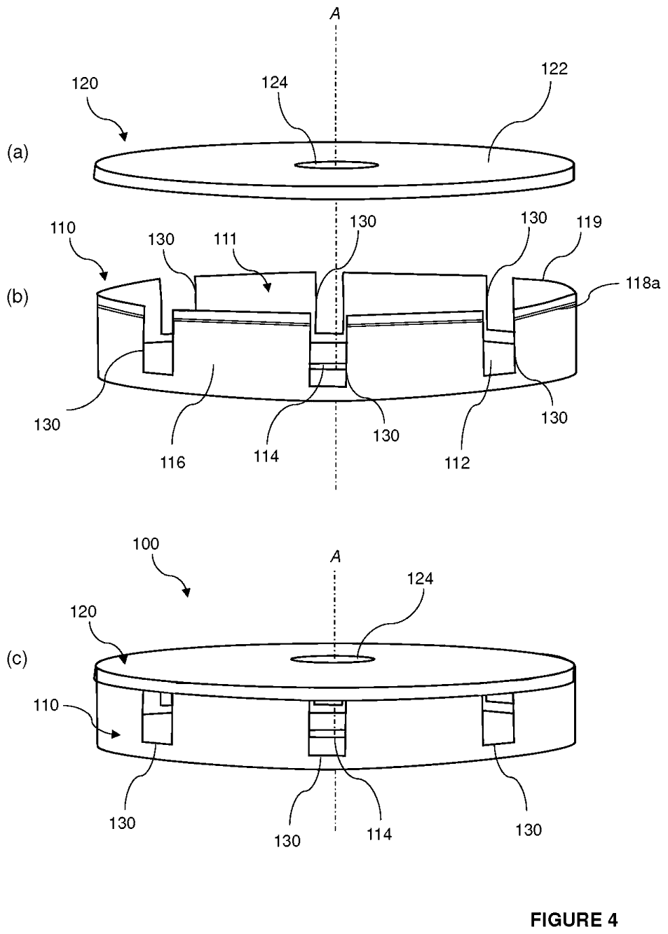

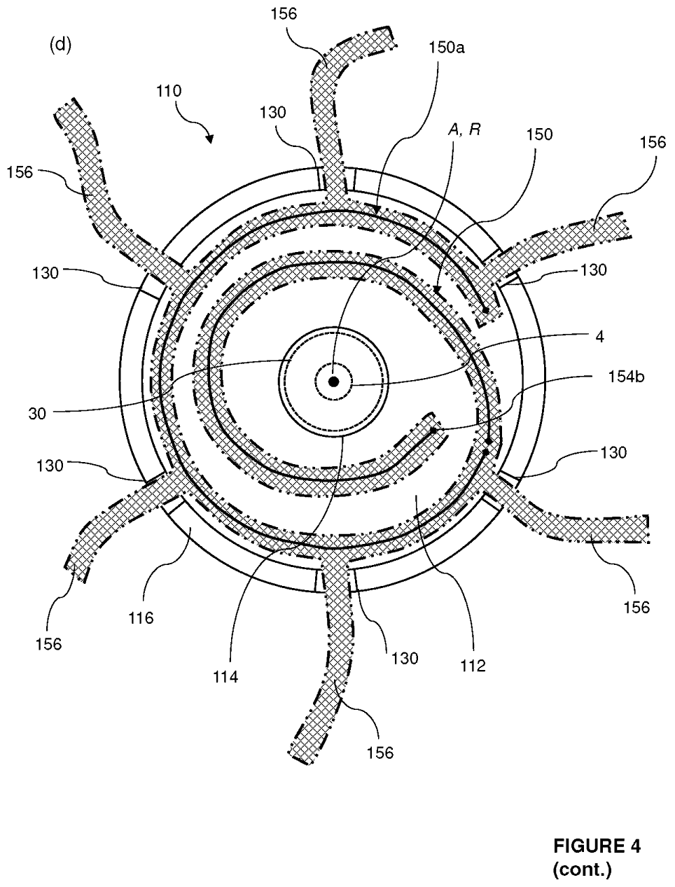

FIGS. 3 and 4 shows views of the component parts of a retaining ring arrangement 100 for use with a centrifuge rotor of a centrifuge. The component parts include a base 110 and a lid 120. The retaining ring arrangement 100 may be used with the particular centrifuge rotor of the type depicted in FIG. 2. In particular, in use, the retaining ring arrangement 100 may be placed on the annular disk shaped surface 301 around the hub 30 of the centrifuge rotor 1A, as discussed in more detail below.

FIG. 3(a) shows a plan view of the lid 120, FIG. 4(a) shows a perspective view of the lid 120, FIG. 3(b) shows a plan view of the base 110 and FIG. 4(b) shows a perspective view of the base 110. The lid 120 and base 110 can be connected as shown in FIG. 4(c), being arranged so that the surface of the lid 120 shown in FIG. 3(a) opposes the surface of the base 110 shown in FIG. 3(b). As such, the surface of the lid 120 and surface of the base 110 shown in FIGS. 3(a) and 3(b) can be considered inner surfaces. FIG. 4(d) shows the base 120 of the retaining ring arrangement in which is arranged a portion of a tubing assembly 150, in a configuration for use within a centrifuge when a sample is loaded.

In FIG. 3(a), the base 110 includes a planar, circular portion 112. A circular aperture or hole 114 is arranged through the planar, circular portion 112 at its centre. The base in FIG. 3(a) could be considered an annular or ring-shaped portion (disc portion). A perimeter wall 116 extends upwardly from the planar portion 112, in particular extending upwardly from the radially outermost edge of the planar portion. A locking mechanism 118a, in this example a first half of a cooperating screw thread, is arranged in proximity to the upper lip 119 (arranged on the uppermost third) of the outer surface of the wall 116.

The lid 120 is a further planar, circular portion 122. The planar, circular portion 122 of the lid has a diameter similar but slightly larger than the planar, circular portion 112 of the base. The lid 120 is slightly larger in order to enable the lid locking mechanism described below to engage. Here, slightly larger means that the diameter is larger by less than 10% or less than 5%.

As with the base, a circular aperture or hole 124 extends through the centre of the planar, circular portion 122 of the lid 120. In the example of FIG. 3(a) the locking mechanism 118b at the lid is a second half of a cooperating screw thread, positioned on one planar surface of the lid, close to the radially outer edge of the planar portion.

The lid 120 and base 110 may be connected together, so as to define a volume between the lid 120 and base 110. A perspective view of the connected base 110 and lid 120 of the retaining ring arrangement 100 can be seen in FIG. 4(c). The lid 120 may be placed on the wall 116 of the base 110, and the lid 120 and the wall 116 may be connected by use of the locking mechanism. In this example, the lid 120 and the wall 116 of the base 110 is connected by screwing together the first and second half of the cooperating screw thread. When connected, a central axis A of the aperture 114, 124 in each of the lid 120 and the base 110 are aligned. In many examples, the aperture 124, 114 in the lid and the base will be the same diameter, and so the edges of the aperture 124, 114 in the lid and the base will also align when the lid 120 and the base 110 are connected.

As already noted, in use the retaining ring arrangement 100 may be placed around the hub 30 of a centrifuge rotor 1A, such as that shown in FIG. 2. In particular, the apertures 124, 114 extending through the centre of the planar portion of the lid 120 and the base 110, respectively, are configured to receive the hub 30 of the centrifuge rotor 1A therethrough. For instance, the retaining ring arrangement 100 may be arranged to rest on the annular disk shaped surface 301 around the hub 30 of the centrifuge rotor 1A when the hub 30 is inserted through the two apertures 114, 124. The diameter of the apertures 114, 124 may be selected so that the edge of the apertures 114, 124 runs closely adjacent to the outer circumference of the hub 30 (as shown in FIG. 4(d) for the base 110 only). The spacing between the edge of the apertures 114, 124 and the outer circumference of the hub 30 will be preferably no more than a few millimetres. The retaining ring arrangement 100 is therefore configured so that, in use, the centre point A of each of the central apertures 114, 124 is arranged on the axis of rotation R of the drive shaft of the centrifuge (or deviates only very slightly therefrom). This means that the retaining ring arrangement 100 experiences approximately equal radial force in every direction when the centrifuge is in use.

In the base portion shown in FIGS. 3(b), 4(b), 4(c) and 4(d), notches 130 are arranged in the perimeter wall 116. The notches 130 are openings or cut outs from the upper lip 119 of the wall 116. The notches 130 provide an opening or passage through the wall 116 from a cavity 111 defined within the base 110 of the retaining ring arrangement 110 to the outside. In the example of FIGS. 3(b), 4(b), 4(c) and 4(d), six notches 130 are shown in the wall 116, each equally spaced around the circumference of the planar portion 112 of the base 110. The notches 130 are intended to receive a portion of a hose of a tubing assembly 150 for use in a centrifuge, as discussed below and shown in FIG. 4(d). Accordingly, the width of each notch 130 should be selected with regard to the external diameter of a hose to be used within the tubing assembly 150. For instance, the width may be substantially the same or greater (for instance, up to 10% greater) than the diameter of a standard hose to be used within the tubing assembly 150. In some cases, it may be useful for the width of the notch 130 to be slightly (up to 5%) less than the diameter of a standard hose to be used within the tubing assembly 150, because this will pinch the tubing assembly in the notch 130 so as to hold the hose in place. However, it will be understood that pinching of the hose is not required to allow the described retaining ring arrangement 100 to function properly.

It will be understood that the retaining ring arrangement 100 will be proportioned so as to fit within the centrifuge, and particularly on a hub 30 of a centrifuge rotor 1A. In some cases, the diameter of the planar portion 112 of the base would not exceed the diameter of the annular disk shaped surface 301 around the hub 30 of the centrifuge rotor 1A, although in most cases it would have a larger diameter than the annular disk shaped surface 301. In every case, the dimensions of the retaining ring arrangement 100 must be appropriate to allow the retaining ring arrangement 100 to be connected to the centrifuge rotor 1A without obstruction of the rotor or its movement. In a particular example, the exterior diameter of the base 110 and lid 120 may be between 140 to 180 mm, with the exterior height of the lid 120 and base 110 when connected using the locking mechanism 118a, 118b (as depicted in FIG. 4(c)) being between 55 to 80 mm. This provides an interior volume for the retaining ring arrangement 100 (being the volume defined between the lid 110 and the base 120 when in their closed configuration) of between 400 to 500 cm 3. The interior volume is intended to be sufficient so that a portion of the tubing assembly 150 that is not extending through the notches 130 in the perimeter wall 116 of the base 110 towards each sample container is instead contained within the volume. For instance, FIG. 4(d) shows a length of the tubing assembly 150 coiled around the hub 30 that is protruding through the central aperture 114 of the planar portion 112 of the base 110. Once the lid 120 is arranged on the base 110, the majority of the tubing assembly 150 is thus safely stowed ready for centrifugation.

Although the planar portions 112, 122 of the base and lid shown in FIGS. 3 and 4 are circular, it will be understood that the planar portions 112, 122 of the base and lid are not limited to this configuration. For instance, other shapes could be used, including polygonal, hexagonal or octagonal, or similar shapes that have rounded or smoothed corners. When polygonal shapes are used, the notches 130 in the wall 116 of the base 110 may be arranged in the region of the corners (or smoothed corners) of the planar portion 112 of the base 110. The planar portion 112 of the base 110 and lid 120 may be considered disc-shaped or ring-shaped, but this should not be construed as being limited to a circular planar portion.

The walls 116 of the base 110 in FIGS. 3 and 4 are shown as upwardly extending from the radially outermost edge of the planar portion 112 of the base 110. It will be understood that upwardly extending means extending away from the planar portion 112, ideally at an angle of more than 45° and less than 135° from the planar portion 112. In the example of FIGS. 3 and 4, the walls 116 are upwardly extending at 90° from the planar portion 112. In some cases, the walls 116 may extend from the planar surface of the planar portion 112 inside the radially outermost edge and closer to the edge of the central aperture 114. Nevertheless, typically it is beneficial to maximise the volume defined between the lid 120 and base 110, which can be achieved by placing the upwardly extending walls 116 closer to the radially outermost edge of the planar portion 112.

In FIGS. 3 and 4 the lid 120 (and more specifically the planar portion 122 of the lid) has a slightly larger diameter than the diameter of the base 110 (and more specifically the planar portion 112 of the base). However, the lid 120 could be substantially the same diameter as the base 110, or even slightly smaller diameter depending on the configuration of the locking mechanism 118a, 118b joining the lid 120 and the base 110. Although not shown in FIGS. 3 and 4, the lid 120 may include downwardly extending walls from the planar portion 124 (for instance at the radially outermost edge) in order to allow connection of the locking mechanism 118a, 118b between the lid 120 and the base 124, or to provide an interference fit between the lid 120 and the base 124.

The lid locking mechanism may be any type of reversible fastener or fastening system for connection or joining of the base and the lid. The cooperating screw thread 118a, 118b at the lid 120 and base 110, as shown in FIGS. 3 and 4, offers an easily reusable and robust mechanism for connection of the lid and base. However, other options can be envisaged, including an interference fit (push fit) connection between the lid and base, clips or clasps between the lid and the base, or other mechanism. In some examples, the locking mechanism could be provided by trapping the retaining ring arrangement 100 between the annular disk shaped surface 301 around the hub 30 of the centrifuge rotor and a screw nut or cap arranged on the drive shaft of the centrifuge.

The notches 130 shown in the retaining ring arrangement 100 of FIGS. 3 and 4 are approximately rectangular. However, it will be understood that they could have almost any shape. In some example, the notches 130 could have an approximately rectangular shape but with a curved lower edge. Alternatively, the notches 130 could be V-shaped, with or without a flat bottom edge. The depth of the notch 130 into the wall 116 is at least as large as the external dimension of a hose in a tubing assembly 150 to be used in conjunction with the retaining ring arrangement 100, but could be deeper than this. The notches 130 may extend the whole height from the uppermost edge 119 of the wall 116 to the planar portion 112 of the base 120. In this case, the wall 116 could be considered as being more than one wall portion, with a notch defined between two of the more than one wall portion. Any number of notches 130 can be introduced at the wall 116 of the base 120, although advantageously the number of notches 130 will be the same as the number of sample holders at the centrifuge rotor. Accordingly, the walls 116 of the retaining ring arrangement 110 will typically incorporate six or eight notches.

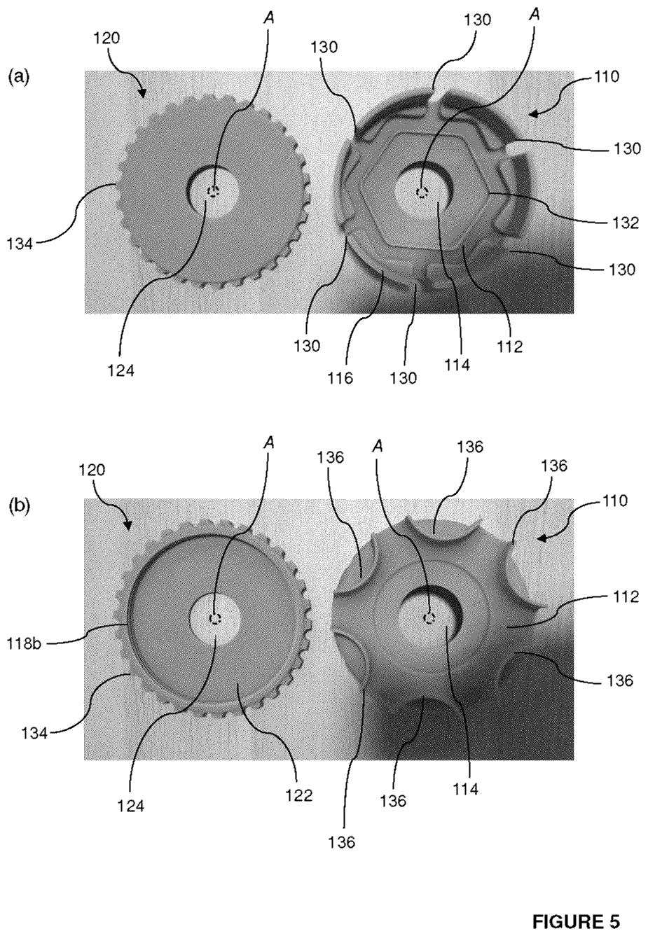

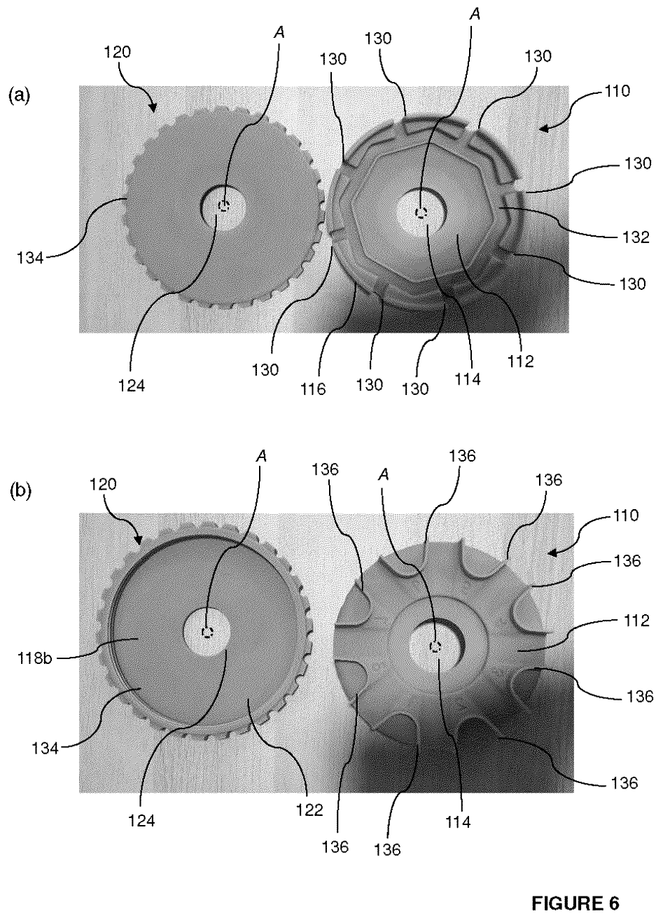

Further specific examples of a retaining ring arrangement 110 according to the present disclosure are shown in FIGS. 5 and 6. Like features as described above in relation to FIGS. 3 and 4 are labelled as such in FIGS. 5 and 6. FIG. 5(a) shows a plan view from above (in other words, of the top surface) of a lid 120 (left hand side) and base 110 (right hand side) of a retaining ring arrangement 100 having six notches 130, and FIG. 5(b) shows a plan view from below (in other words, of the bottom surface) of a lid 120 (left hand side) and base 110 (right hand side) of the same retaining ring arrangement 100 having six notches 130. FIG. 6(a) shows a plan view from above (in other words, of the top surface) of a lid 120 (left hand side) and base 112 (right hand side) of a retaining ring arrangement 100 having eight notches 130, and FIG. 6(b) shows a plan view from below (in other words, of the bottom surface) of a lid 120 (left hand side) and base 110 (right hand side) of the same retaining ring arrangement 100 having eight notches 130.

Some additional details can be seen in the retaining ring arrangements of FIGS. 5 and 6 than compared to the retaining ring arrangement of FIGS. 3 and 4. In particular, it can be seen that the top surface of the planar portion 112 of the base 110 includes some indentations 132, which may be useful for directing and channelling a hose of the tubing assembly 150 when in use. In addition, it can be seen that the radially outermost edge of the lid 120 includes protrusions or smoothed serrations 134. This aids the grip of a user to open and close the screw thread employed as a locking mechanism 118a, 118b between the lid 120 and base 110 in these examples. Finally, fins 136 (which also could be known as stabilisers, separators or partitions) can be seen extending downwardly from the bottom surface of the planar portion 112 of the base 110. The fins 136 are shaped so that, where the diameter of the base 110 is larger than the diameter of the annular disk shaped surface 301 around the hub 30 of the centrifuge rotor, the fins 136 fit between the holding arms 2 extending radially outward from the central body 20 of the centrifuge rotor 10. The fins 136 provide a secure, stable fit and alignment for the retaining ring arrangement 100 on the hub 30 of the centrifuge rotor, and help to prevent rotational movement of the retaining ring arrangement 100 on the hub 100 relative to the rotation of the hub itself.

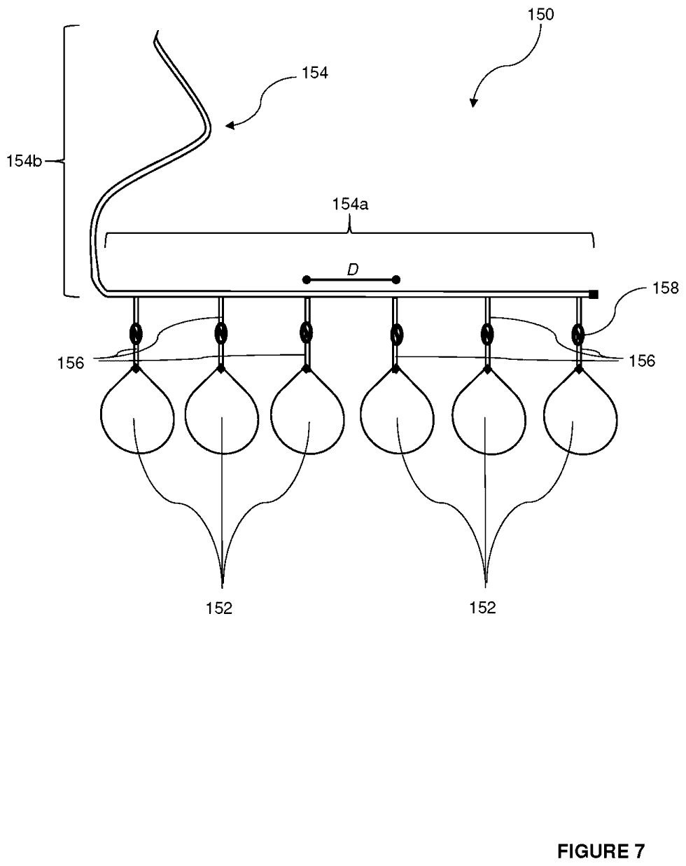

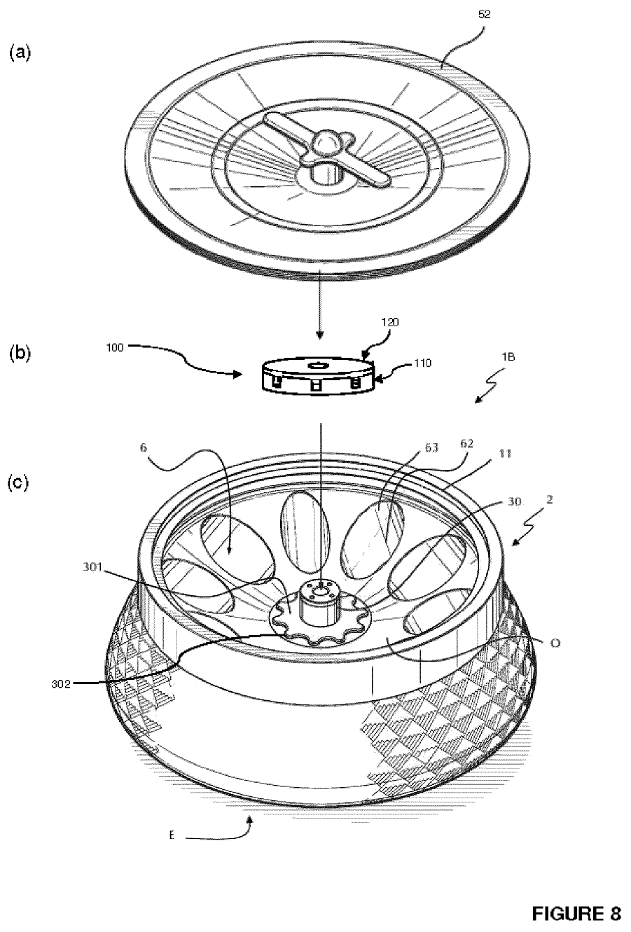

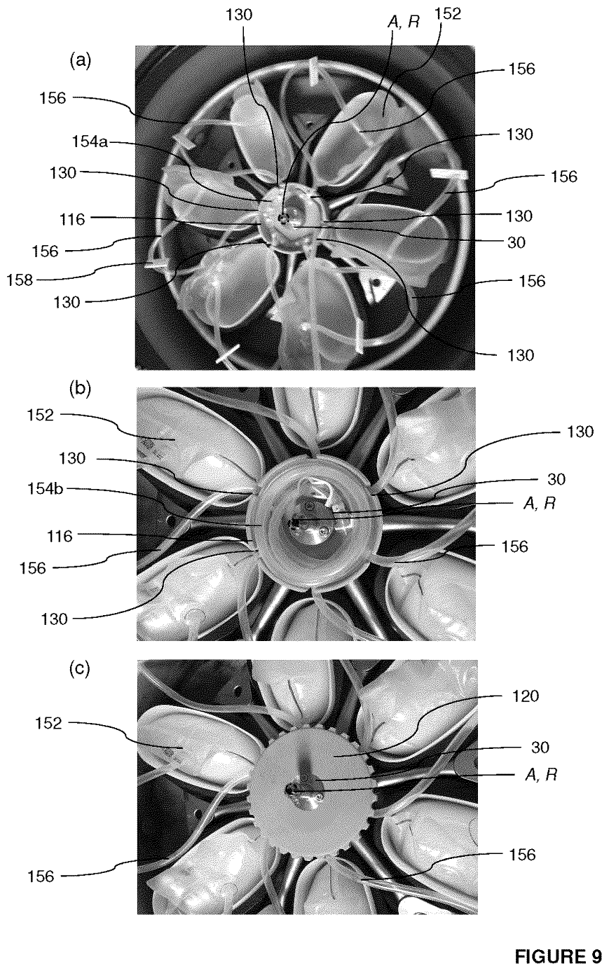

The retaining ring arrangement 100 is discussed below when in use, with reference to FIGS. 8 and 9. However, although a tubing assembly as described in WO/2019/166998 could be used in conjunction with the described retaining ring assembly 100, a novel tubing assembly 150 described here is particularly beneficial for use with the retaining ring assembly 100 described above. The novel tubing assembly 150 is shown in FIG. 7.

The tubing assembly 150 of FIG. 7 comprises a plurality of sample containers 152, being a number of film bags which can be single-use (in other words, intended to be disposed of after one use). Each film bag is formed by two congruent plastic films. The two films are welded to one another along a circumferential seam and enclose a sample space between them. A port for a tube is arranged welded in a liquid-tight manner in a seam connecting the films. Although not shown in FIG. 7, the port may have a closing valve, including a reversible tap or pierceable membrane.

The tubing assembly 150 of FIG. 7 further comprises a main hose 154 and a plurality of feed hoses 156. Each feed hose 156 is directly connected at a first end to the main hose 154, in sequence. In other words, each feed hose 156 directly branches from a manifold portion 154a (or trunk portion) of the main hose 154. A further portion of the main hose 154 is a supply portion 154b, from which no branches are made.

A second end of each feed hose 156, at an opposite end to the first end, is connected directly to a sample container 152. In particular, as shown in FIG. 7, the second end of each feed hose 156 is connected directly to a port at a respective film bag sample container. An optional clamp 158 is shown in FIG. 7 arranged on the length of each feed hose 156. The clamp 158 is for pinching the feed hose 156 to close the channel therethrough. In the example of FIG. 7, each sample container 152 is connected to a dedicated feed hose 156.

The tubing assembly 150 can be used for separation of a sample in a centrifuge. The sample is in a liquid suspension, for instance a cell sample in a liquid. In order to use the tubing assembly 150 in a centrifuge the sample containers 152 (film bags) must be filled. For this process, an end of the supply portion 154b of the main hose 154 (the end being an opposite end of the supply portion 154b than connected to the manifold portion 154a) may be connected to a reservoir (not shown) of the sample for separation. The sample may then be passed through the main hose 154 (first through the supply portion 154a, then through the manifold portion 154b) and into each feed hose 156 to be passed approximately simultaneously into each of the film bags (acting as sample containers 152).

Once filled to the required level, the sample containers 152 can be closed (either via the use of the optional clamp 158 at each feed hose 156, or by closure of a valve at the port to the film bag). The supply portion 154b of the main hose 154 can then be disconnected from the reservoir of sample. If required, the main hose 154 could be shortened at this time, by cutting of the main hose 154 to a preferred length. The tubing assembly 150 can then be used for centrifugation together with the above described retaining ring arrangement 100 and a centrifuge rotor, as described below with reference to FIGS. 8 and 9.

FIG. 8 shows a centrifuge, comprising a centrifuge rotor 1B, and a lid 52 in an exploded view. As compared to the centrifuge rotor 1A of FIG. 2, the centrifuge rotor 1B in FIG. 8 is a fixed-angle centrifuge rotor. As noted above, this type of rotor has sample receptacles that do not move or ‘swing out’ during rotation of the rotor around the drive shaft of the centrifuge. The fixed-angle rotor 1B is essentially pot-shaped and has an outer wall 11 with a central opening arranged on the insertion side E and not visible in the figure, into which a hub 30 is inserted in order to receive the drive head of a centrifuge drive. The hub 30 projects beyond the top side O of the fixed-angle rotor 1B opposite the insertion side E. A plurality of cavities 62, each of which has an opening 63 to the top side O, is present in the interior of the fixed-angle rotor. These cavities 62 represent the sample receptacles 6 of the fixed-angle rotor 1B for receiving sample containers. In the example shown, the sample receptacles 6 have an oval cross section and can thus be used for centrifuging film bags as described in respect of the tubing assembly 150 of FIG. 7.

In order to position within the centrifuge (and more particularly, the centrifuge rotor 1B) the sample bags 152, for instance being part of the tubing assembly 150 of FIG. 7, a retaining ring arrangement 100 according to the present disclosure can be used. Firstly, the base 110 of the retaining ring arrangement 100 can be placed around the hub 30 of the centrifuge rotor 1B, so that the hub 30 extends through the central aperture 114 of the base 110 of the retaining ring arrangement 100. The arrows in FIG. 8 show the direction of insertion of the retaining ring arrangement 100 onto the top surface of the centrifuge rotor 1B. The base 110 of the retaining ring arrangement 100 can rest loosely on top of the annular surface 301 surrounding the hub 30, wherein fins 136 extending downwards from the bottom surface of the planar portion 112 of the base 110 of the retaining ring arrangement 100 can then lie between the protrusions 302 at the radially outermost edge of the annular portion 301. The fins 136 retain the base 110 of the retaining ring arrangement 100 into position. It will be understood that when using a ‘swing-out’ type rotor 1A, the fins 136 can extend downwards from the bottom surface of the base 110 to protrude between radially extending arms 2.

Next, as shown in FIG. 9(a) using the retaining ring arrangement 100 of FIG. 5, each sample container 152 (being a single-use film bag) of the tubing assembly 150 can be placed in a different one of the sample receptacles 6 of the centrifuge rotor 1B. The hoses of the tubing assembly 150 can be arranged within the cavity 111 defined in the base 110 of the retaining ring assembly 100. In particular, the feed hose 156 to each sample container 156 can be arranged to pass through a respective notch 130 of the retaining ring arrangement 100 whilst having the manifold portion 154a of the main hose 154 placed inside the cavity 111 of the base. Accordingly, the manifold portion 154a forms a loop inside the cavity of the base 110, with the feed hoses 156 extending radially outwards through the notches 130. This arrangement is also illustrated schematically in FIG. 4(d). In some cases any loose sections of the feed hoses 156 extending between the retaining ring arrangement 100 and the sample containers 152 may be held or fastened at a clasp or clip 158 on a portion of the centrifuge rotor 1B, as shown in FIG. 9(a). It is noted that the number of notches 130 in a retaining ring arrangement 100 advantageously should be no less that the number of sample containers 152 comprised within the tubing assembly 150 used in conjunction with the retaining ring arrangement 100.

The sample containers 152 (such as the single-use film bags) comprised within the tubing assembly 150 can be placed in the sample receptacles 6 before or after filling with the sample. In either case, the sample containers 152 will be filled by connection of the supply portion 154b of the main hose 154 to a sample reservoir, as discussed above. FIG. 9(a) shows the sample container bags 152 having been placed in sample receptacles 6 of the centrifuge rotor before filling with sample.

After mounting of the sample containers 152 in the centrifuge as described with respect to FIG. 9(a) (and subsequent to filling with sample, if necessary) the supply portion 154b of the main hose 154 is coiled within the cavity 111 of the base 110 of the retaining ring arrangement 100 (for instance, being wrapped around the hub 30 of the rotor). The arrangement of the supply portion 154b of the main hose 154 within the base 110 of the retaining ring arrangement 100 is shown in FIG. 9(b), and also shown schematically in FIG. 4(d) (in which the supply portion 154b of the main hose 154 is shown as being fairly short, for clarity).

Finally, the lid 120 of the retaining ring arrangement 100 is placed on the wall 116 of the base 110, and connected using the locking mechanism 118a, 118b. In the particular example of FIG. 9(c) using the ring retaining arrangement 100 of FIG. 5, the lid 120 is screwed on to the base 110 of the retaining ring arrangement 100. Once the lid 120 is connected to the base 110, the main hose 154 of the tubing assembly 150 is entirely contained within the volume defined between the base 110 and the lid 120 of the retaining ring arrangement 100. The lid 52 of the centrifuge can then be closed and centrifugation can take place according to a known procedure.

Use of the described retaining ring arrangement 100, which securely contains the whole of the main hose 154 during use as a result of the lid 120, base 110 and connecting lid-locking mechanism 118a, 118b, reduces the likelihood of damage to the centrifuge as a consequence of forces applied to portions of the main hose 154. Furthermore, the initial arrangement of a tubing assembly 150 within the centrifuge rotor is more straightforward and less prone to error when using the described retaining ring arrangement 100. The ring retaining arrangement 100 provides a good alignment of feed hoses 156 of the tubing assembly 150 to sample containers 152 by channelling and directing them through the notches 130. These advantages, in turn, allow for quicker set-up of the centrifuge and the requirement of less expertise for a user of the equipment.

Although other configurations for the tubing assembly could be used in conjunction with the retaining ring arrangement 100 of FIGS. 3 to 6, it will be understood that use of the tubing assembly 150 of FIG. 7 is particularly beneficial. In particular, the configuration shown having feed hoses 156 connected directly and in sequence to the main hose 154 fits most conveniently within the cavity 111 of the base 110 of the described retaining ring arrangement 100. The configuration of the tubing assembly 150 of FIG. 7 can be arranged so that the manifold portion 154a of the main hose 154 is arranged in a ring inside the cavity 111 of the base 110, with each of the feed hoses 156 extending radially from said ring. In some beneficial configurations, the spacing between a connection of a first feed hose to a connection of an adjacent second feed hose at the manifold portion 154a of the main hose 154 of the tubing assembly 150 (marked as distance D in FIG. 7) is approximately the same length as the distance of the arc between two notches 130 (more particularly the respective centre of the said two notches) in the wall 116 of the base 110 of the retaining ring arrangement 100 (said arc marked as distance d in FIG. 3(b)). At least approximate matching of the distances D and d allows the tubing assembly 150 to be compactly arranged within the cavity 111 defined in the base 110 of the retaining ring arrangement 100. Here, approximately the same length means the distance D being within ±10% of the distance d.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after another step, this does not preclude intervening steps being performed. Any of the features described may be combinable, except where the context or description of a set of given features precludes it.

A method of manufacturing and/or operating any of the systems disclosed herein is also provided. The method may comprise steps of providing each of the features disclosed and/or configuring or using the respective feature for its stated function.

1. A retaining ring arrangement for a centrifuge rotor of a centrifuge, comprising:
a base, having a planar portion with an aperture centrally therethrough, the base further having a perimeter wall extending upwardly from the planar portion to define a cavity bounded by the planar portion and the perimeter wall;
a lid, being a further planar portion with an aperture centrally therethrough, configured to be placed on the perimeter wall of the base and opposite the planar portion of the base so that a central axis through the aperture through the planar portion of the base aligns to a central axis through the aperture through the planar portion of the lid;
a lid-locking mechanism at the lid and at the base, so that when the lid-locking mechanism is closed it connects the base and the lid; and
wherein when the base and the lid are connected the cavity is enclosed between the base and the lid to provide a volume for containing at least a portion of a hose of a tubing assembly used in the centrifuge.

2. The retaining ring arrangement of claim 1, wherein the perimeter wall is configured having at least one notch for receiving a further portion of a hose of the tubing assembly therethrough.

3. The retaining ring arrangement of claim 2, wherein the perimeter wall comprises at least a first and a second wall portion, and a first notch of the at least one notch is configured as a gap between the first and the second wall portion.

4. The retaining ring arrangement of claim 2, wherein the perimeter wall comprises 6 notches or 8 notches.

5. The retaining ring arrangement of claim 1, further comprising one or more fins extending downwardly from the planar portion of the base, the one or more fins extending in a direction opposite to the extension of the perimeter wall.

6. The retaining ring arrangement of claim 1, wherein the lid-locking mechanism, when closed, connects the perimeter wall of the base with the lid.

7. The retaining ring arrangement of claim 6, wherein the lid-locking mechanism is a cooperating screw thread at the perimeter wall of the base and at the lid.

8. The retaining ring arrangement of claim 1, wherein the central aperture in the planar potion of the base and the central aperture in the planar potion of the lid is configured to receive at least a portion of a central rotator hub of the centrifuge rotor therethrough.

9. The retaining ring arrangement of claim 1, wherein, in use, the retaining ring arrangement is arranged at the centrifuge rotor so that the central axis through the aperture through the planar portion of the base and the lid coincides with an axis of rotation of the centrifuge rotor.

10. A tubing assembly for connecting a plurality of sample containers for use in a centrifuge, comprising:
a main hose; and
a plurality of feed hoses, each feed hose at a first end directly connected to the main hose;
wherein a different sample container of the plurality of sample containers is directly connected to a second end of each feed hose of the plurality of feed hoses, the second end being opposite to the first end.

11. The tubing assembly of claim 10, further comprising the plurality of sample containers.

12. The tubing assembly of claim 10, wherein a first feed hose is connected to the main hose and a second feed hose is connected to the main hose adjacent to the connection of the first feed hose, and a spacing between the connection of the first feed hose and the second feed hose to the main hose is substantially equal to a length of an arc between a centre of two rotationally adjacent notches in a retaining ring arrangement.

13. A centrifuge, comprising:
a centrifuge rotor; and
the retaining ring arrangement of claim 1;
wherein the retaining ring is arranged on the centrifuge rotor such that the central axis through the aperture through the planar portion of the base and the lid coincides with an axis of rotation of the centrifuge rotor.

14. The centrifuge of claim 13, wherein the centrifuge rotor comprises one or more sample receptacles each for receiving one of a plurality of sample containers; and
the centrifuge further comprises:
a tubing assembly, comprising a main hose and a plurality of feed hoses,
each feed hose connected to a respective one of the plurality of sample containers;
wherein the tubing assembly is arranged in the centrifuge rotor so that each of the plurality of sample containers is arranged in a respective sample receptacle, and wherein at least a portion of the main hose of the tubing assembly is contained in the volume of the retaining ring arrangement.
